(19) United States
(12) Patent Application Publication
(10) Pub. No.: US 2003/0025595 A1
(43) Pub. Date: Feb. 6, 2003

(54) Tactile interface

(76) Inventor: Edwin Langberg, Medford, NJ (US)

Correspondence Address: EDWIN LANGBERG, 56 BRIDGE ROAD, MEDFORD, NJ, 08055

(21) Appl. No.: 09/887,843

(22) Filed: Jun. 22, 2001

(51) Int. Cl. H04B 3/36

(52) U.S. Cl. 340/407.1

(57) ABSTRACT

An active drive is used to improve the response time of any vibrotactile transducer. A closed loop implementation of such a drive monitors the vibrotactile stimulus and by comparing it with an input signal generates an error signal driving the transducer. In an open loop active drive implementation, an input signal is shaped into a driving signal of a form designed to produce a desired vibrotactile response. The tactile interface adapts flat vibromotor transducers used as a silent alarm in cell phones for vibrotactile application. The adaptation involves means of fastening vibromotors to the skin implemented by adhesive tape, adjustable elastic band or specialized glove. A surround button is used for fastening vibrotactile transducers under tight fitting garments such as flight suits

This invention was made with Government support under a grant awarded by the National Institutes of Health. The Government has certain rights in this invention.

### BACKGROUND OF THE INVENTION

The present invention relates broadly to a tactile communication interface. Specifically, it addresses the use of such communication interface in aids for the handicapped, e.g., for the hearing impaired to translate sound-carried information into patterns of tactile stimuli.

Miniature vibromotors based on the rotation of an unbalanced mass have been developed and mass-produced for applications as “silent alarms” in cell phones. One cylindrical implementation of such a vibromotor is shown in FIG. 2: Cylindrical vibromotor as used in prior art. As can be seen In FIG. 2, the miniature DC cylindrical vibromotor has an unbalanced mass attached to an end of a rotating shaft. The motor and the unbalanced mass are separate entities. The geometry of the assembly is that of a cylinder with an axial length larger than the diameter of the cylinder. The cylindrical vibromotor base (assembly board in FIG. 2) is parallel to the shaft, and the centrifugal force created by the unbalanced mass is at a right angle to the base.

A flat vibromotor is a more recent implementation of a miniature vibromotor. The flat vibromotor uses an unbalanced mass for a silent alarm and is mounted in portable phones and pagers. FIG. 3 shows a flat vibromotor as used in prior art. Such a flat vibromotor developed as a silent incoming call indicator, is shown in U.S. Pat. No. 4,864,276 (Tribbey et al., Sep. 5, 1989). Further developments of these vibromotors are shown in U.S. Pat. No. 6,051,900 (Yamaguchi, Apr. 18, 2000) and 6,169,348 (Won, Jan. 2, 2001).

The flat vibromotor pancake geometry and small size are accomplished by an integral configuration where a motor rotor 29, rotating around a short stationary shaft 31, is unbalanced. There is no need for an external rotating shaft with an unbalanced weight attached to it, such as used in cylindrical vibromotors. The unbalanced rotor 29 in the flat vibromotor creates a rotating centrifugal force parallel to its base surface.

Vibrotactile transducers convert an electrical signal into a tactile stimulus. A wide variety of transducers have been used mostly using piezoelectric and electromechanical conversion. As attractive as mass-produced vibromotors are for application as vibrotactile transducers, they have some serious shortcomings. The tactile sense is capable of resolving a stimulus as short as 10-20 ms. Yet, the transient response of “silent alarm” vibromotors is of the order of 200 ms. While this delay is of little consequence in telephone “ring” indication that lasts several seconds, it represents a serious limitation in the tactile information transfer rate. Another issue is the development of suitable fastening means of the vibromotor to skin.

U.S. Pat. No. 6,088,017 (Tremblay et al., Jul. 11, 2000) addresses specifically and narrowly the use of cylindrical vibromotors, i.e., comprising a motor, a rotating shaft, and an unbalanced weight attached to such rotating shaft, for vibrotactile transducers. The transducer in Tremblay is equivalent to what is defined here as a cylindrical vibromotor since it uses an external rotating shaft and an unbalanced weight attached to it. Flat vibromotors, on the other hand, use an unbalanced rotor, rotating on a stationary shaft.

Flat vibromotors have a number of key advantages for use as vibrotactile transducers. Their smaller size, light weight, and flat faces make them easily adaptable to contact with the skin. On the other hand, cylindrical vibromotors used as vibrotactile transducers produce primary forces perpendicular to the skin at the weighted end. The primary forces of flat vibromotors used as vibrotactile transducers are parallel to the skin, which lead, as will be discussed further in reference with FIG. 8, to a profound difference in the tactile dynamics.

The concept of substitution of the tactile sense for lost or impaired hearing is well documented both in technical and patent literature. This concept is based on translating acoustically carried information via vibrotactile transducers into a tactile pattern perceived by a hearing impaired person. With appropriate training, a specific tactile pattern can be associated with a specific acoustical signal. An example of technical literature on this subject is a book edited by I. R. Summers, titled Tactile Aids for the Hearing Impaired, London: Whurr Publishers, 1992. U.S. Pat. No. 5,035,242 (Franklin et al., Jul. 30, 1991) discusses the use of tactile stimulation to aid the hearing impaired in speech perception and specifically addresses the use of tactile arrays for this purpose.

At present, among the aids for the hearing impaired, tactile aids represent a rather marginal proportion of the market. A competing, and much more successful technology to aid the hearing impaired in regaining hearing capability, is a cochlear implant where an acoustical speech signal is converted into electrical excitation of an array of electrodes implanted into the cochlea. The basis of the success of the cochlear implant is the much greater information transfer rate of the cochlear array as compared with the state of the art tactile arrays, e.g., as represented by an array spread across a chest as shown in the aforementioned U.S. Pat. No. 5,035,242. In order to make tactile aids viable as aids for the hearing impaired, the intention of the present invention is to increase the information transfer rate and to improve the wear-ability of the tactile array.

In order to transmit information, a single vibrotactile transducer can be modulated in amplitude and frequency of vibration. The tactile sense is limited in its ability to reliably recognize many of those amplitude and frequency states. In order to increase the information transfer capability, an array of such vibrotactile transducers can be employed. As long as the user can recognize the location of an energized transducer in an array, another dimension in information transfer can be realized. Unfortunately, localization capability is typically limited because vibrational waves spread across contiguous skin beyond the immediate contact with the transducer. A hand wearable and specifically, finger wearable array proposed by this invention improves the localization capability.

The present invention adapts the inexpensive, mass-produced telephony vibromotors designed for “silent alarm” application to the novel role as effective vibrotactile transducers by modification in a driving means that results in reduction in response delay and by specialized means and methods of fastening of flat vibromotors to the skin. The invention also describes the use of these vibromotors in arrays with improved information transfer rate.

### SUMMARY OF THE INVENTION

It is, therefore, a general object of the present invention to adapt vibromotors, and especially flat vibromotors, for efficient vibrotactile skin stimulation. As the name implies, a flat vibromotor has a large top face and a large bottom face surface and a small height. In addition to this favorable form factor, the flat vibromotor is small, lightweight, and energy efficient and because of mass production, quite inexpensive. Flat vibromotors, developed for an unrelated application as a silent incoming call indicator in cellular phones, have been adapted in this invention to the role of vibrotactile transducers.

In order to reduce a delay between a signal and actual tactile stimulation, this invention employs an active drive. Such a drive senses the tactile stimulus and by comparing it with an input signal, generates an error signal used to drive the vibromotor. The active drive significantly improves response time of the resulting vibrotactile transducer so that the capability of the tactile sense rather than the transducer determines the tactile information transfer rate.

When used as the vibrotactile transducer of this invention, the lower face of the flat vibromotor in held against the skin by a fastener attached to the upper face. The centrifugal forces tug on the fastener and cause the tactile excitation to be a mixture of tangential and normal forces acting on the skin and resulting in a rich tactile excitation. This design of the fastener assures a tactile effectiveness of the flat vibromotor for tactile excitation. This may appear surprising because the dynamics of the originally intended operation of this vibromotor, namely shaking of a cellular phone in the pocket of the user, it substantially different from skin contact dynamics. Since tactile aids are typically battery-operated portable devices, worn for long periods of time, it is an essential that tactile transducers must be efficient converters of electrical to vibratory power.

Another object of this invention addresses fastening of a vibrotactile transducer to the skin in applications such as encountered in a military pilot's pressure suit. In this operation, fastening of the flat vibromotor requires a specialized fastener that neutralizes the excess bias pressure.

Yet another object of this invention is a hand-worn vibrotactile array suitable for prolonged use without encumbering a user's hands. Flat vibromotors used as vibrotactile transducers have properties needed for an efficient implementation of a hand-wearable tactile array that maintains hand-free function. The tactile properties of fingers and hands, exploited by the flat transducers used in the array, help resolve the heretofore-unsolved problem of adequate tactile information bandwidth for viable tactile speech perception. Superior tactile communication properties of the hands have been used in many tactile aids going back to Braille, a reading substitute by sensing arrays of indentations using fingertips. These aids suffer from a major shortcoming: To the extent that they occupy a hand, they cannot be used continuously since hands have many other essential functions. This invention describes a tactile array that is designed specifically so that it can be worn continuously on a hand or hands without interfering with other functions. It therefore affords improved tactile information bandwidth of the hands without diminishing their functionality.

The innocuous nature of the array in this invention is assured by small size and light weight of the flat vibromotors and by their location on the palmar surface of the fingers and thumb at the mid-portion of the proximal phalanx, substantially midway between the PIP and the MCP joints. Also since the vibrotactile transducer diameter is smaller than a typical finger, the interior locations of the flat vibromotors assures that most of the time, the array is not visible conspicuous.

### BRIEF DESCRIPTION OF THE DRAWINGS

FIG. 1: Block diagram of a tactile interface.

FIG. 2: Cylindrical vibromotor as used in prior art.

FIG. 3: Flat vibromotor as used in prior art.

FIG. 4: Exploded view of a flat vibromotor.

FIG. 5: Cross-section view of a flat vibromotor.

FIG. 6: Wiring connections of a flat vibromotor.

FIG. 7: Active drive.

FIG. 8: Tactile dynamics of a flat vibromotor used as a vibrotactile transducer.

FIG. 9: Tape fastener.

FIG. 10: Elastic band fastener.

FIG. 11: Surround fastener

FIG. 12: Glove array.

### DETAILED DESCRIPTION OF THE PREFERRED EMBODIMENT

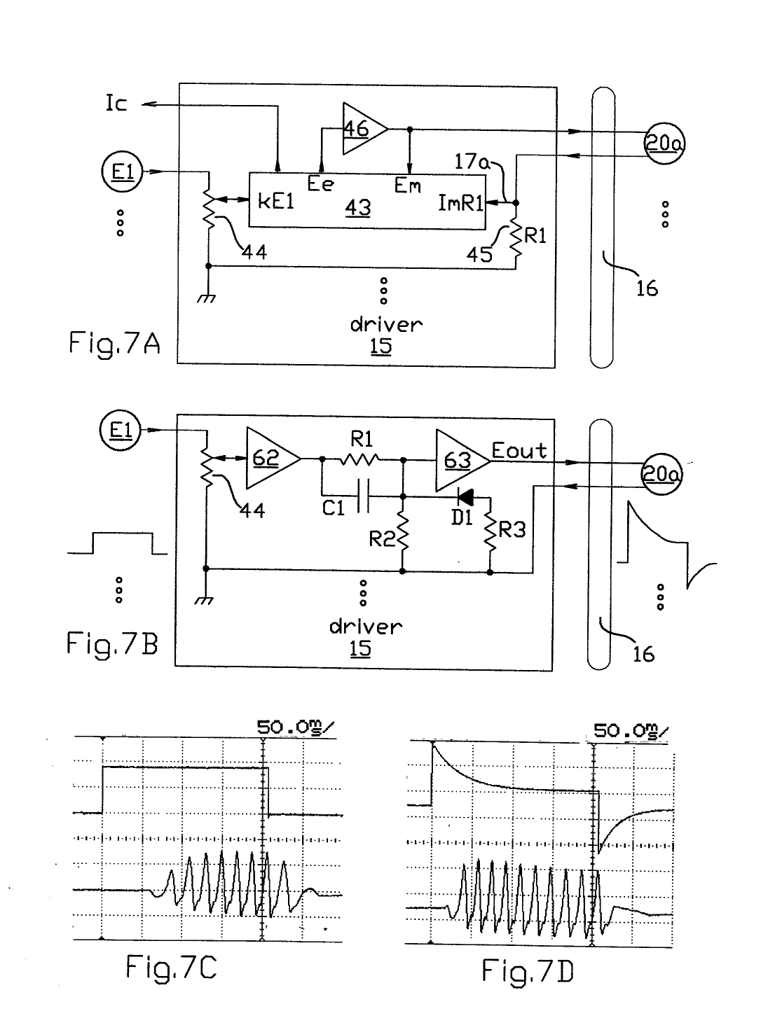

A six-channel block diagram of a tactile interface is shown in FIG. 1. Input signals E1 through E6 are fed into driver 15. After processing and amplification, outputs of the six channels connect through cable 16 to flat vibromotors 20a through 20f. Vibromotors are attached to the skin via fastening means 18a through 18f and cause tactile stimulation of skin 19. Dashed lines 17a-17f indicate a possible feedback connection that samples the tactile stimulation in one alternative implementation of driver 15. In this implementation, described further in connection with FIG. 7a, driver 15 uses these feedback signals to improve fidelity of the tactile stimulus as compared to the input signal that represents the desired tactile output.

The origin of input signals E1-E6 is not directly pertinent to this invention. One example is an aid for the hearing impaired where a microphone receives ambient sound and converts it into an electrical signal. This electrical signal is amplified, filtered, and processed in a speech processor so that sound patterns are translated into six signals, forming inputs E1 through E6 to driver 15.

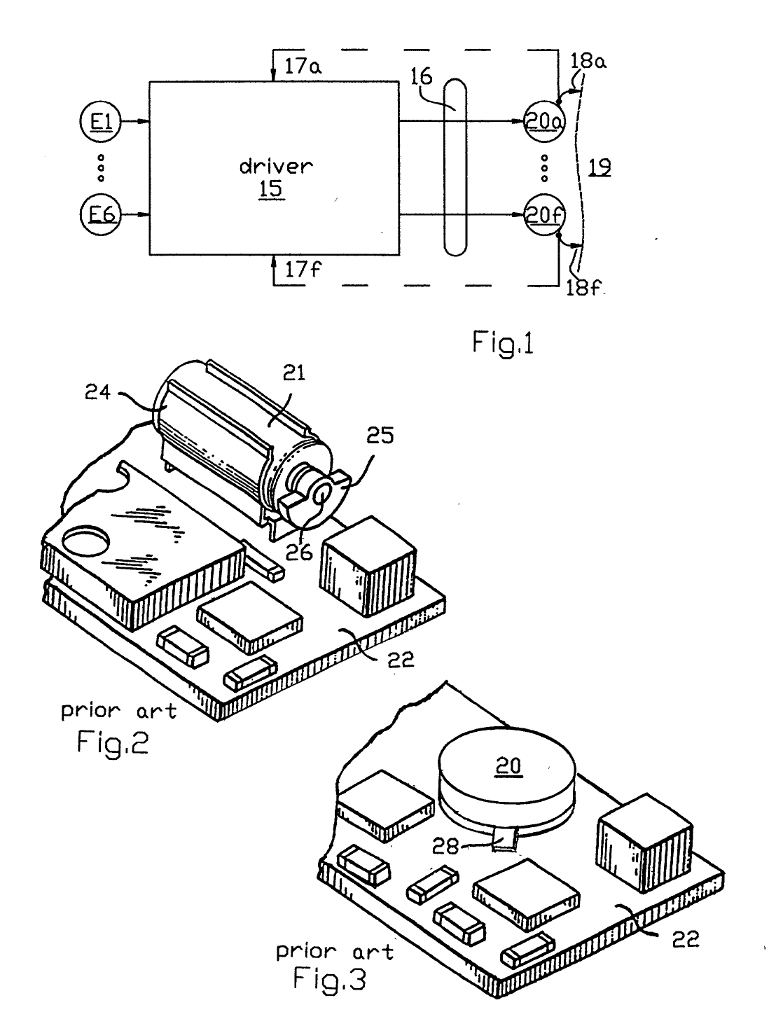

A cylindrical vibromotor 21 as used in prior art is shown in FIG. 2: Vibromotor 21 is attached to a cellular phone assembly board 22 by a clip 24. An unbalanced mass 25 attached to an end of a rotating shaft 26 of a cylindrical miniature DC vibromotor 21 creates a centrifugal force rotating in a plane perpendicular to both the shaft 26 and the board 22. Typical diameter of the cylindrical vibromotor 21 is 6.3 mm and overall length including the unbalanced mass 25 is 21.6 mm. Typical weight is 4.5 g. There will be no further reference to cylindrical vibromotors so that “vibromotor” in the remaining text will refer to a flat vibromotor.

Flat vibromotor 20 as used in prior art is shown in FIG. 3: Vibromotor 20 is fully self enclosed in a disk-shaped enclosure typically less than 15 mm in outside diameter and less than 3.5 mm thick. Vibromotor 20 is attached on its bottom flat face to the cellular phone assembly board 22. The vibromotor typically weighs less than 2 g and has an electrical to mechanical energy conversion efficiency better than 20%. The unbalanced rotor 29 rotates in a plane parallel to the board generating centrifugal forces parallel to the board 22. Electrical contacts are brought up on tab 28.

An exploded view of the main electro magnetic components of the flat vibromotor 20 used in the preferred embodiment, is shown in FIG. 4 and in a cross-section view is shown in FIG. 5. The base of rotor 29 is a semi-circular board with a smaller semicircular bulge accommodating a bearing 30 for rotation around a stationary shaft 31 permanently attached to a bottom lid 33. Rotor 29 carries on its top surface three pie-slice shaped coils 34a, 34b and 34c. The bottom surface of rotor 29 has printed circuit wiring 35 connecting the coil wires to each other and to a six-segment commutator 36, surrounding bearing 30 on the bottom surface of rotor 29.

A magnet ring 39 with four transversely magnetized regions marked with magnetic polarity designations as N(orth) and S(outh) is the main component of a stator 40. Other stator components comprise a pair of commutator brushes 41a and 41b located between the shaft and the magnet. The upper ends of the brushes 41 protrude above the magnet ring and in operation, make contact with commutator 36 on rotor 29. Commutator brushes 41 are internally connected to power contacts on tab 28 and through them to the external cable 16. Top and bottom metal lids 32 and 33 respectively enclose the assembly.

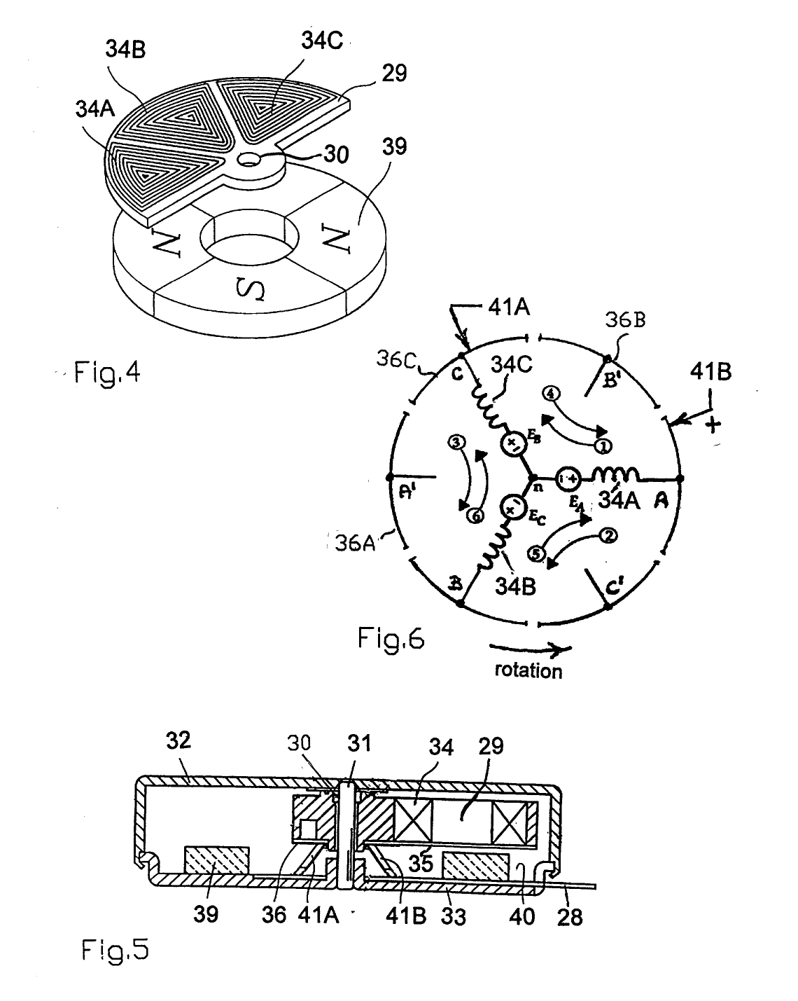

Flat vibromotor 20 is in principle a DC motor with a rotor 29 sliced along a diagonal, thereby producing an unbalanced rotating mass and centrifugal forces associated with such rotation. The rotor coils 34 rotate above the transversely magnetized segments of magnet ring 39. Torque is generated by a magnetic interaction of the commutated current flowing through the rotor coils 34 and the stationary permanent magnet ring 39. Wiring connections of vibromotor 20 are shown in FIG. 6. Three rotor coils 34a, 34b an 34c are joined in the center and connected to diagonally opposite commutator 36 segments A-A′, B-B′, and C-C′. The inside arrows show current direction, always through two out of three coils 34 during six 30-degree segments of commutation. Commutator brushes 41 are spaced 90 degrees apart. Ea, Eb and Ec are the velocity induced coil voltages.

Vibromotors typically require ˜0.2 seconds to reach a full steady state velocity. A typical phone ring last several seconds so that in its “silent alarm” telephony application, a vibromotor operates largely at full steady state speed. In operation as a vibrotactile transducer, it is desirable to start and stop rotation within the response time of the tactile sense that is of the order of 20 ms to optimize the tactile information transfer rate. An Active drive of this invention accomplishes this objective by speeding up the response of the vibromotor.

A block diagram of the active drive 15 in a closed-loop implementation is shown in FIG. 7A. This active drive generates an error signal equal to a difference between an actual and desired speed of the motor. A control circuit 43 implemented with operational amplifiers, has three inputs. Controlling input signal E1 is applied to an equalizing potentiometer 44. The equalization is used to produce equal tactile stimulus for equal input signal at all sights. Equalized input signal k*E1 is one of the inputs to control circuit 43. The vibromotor driving voltage Em is a second input. A third input is the vibromotor current sampling signal R1*lm obtained from a resistor R1 (45). To reduce resistive losses the value R1 is much smaller than the motor resistance Rm. By proper amplification inside of 43, one obtains signal −lm*Rm and then by subtraction, a velocity-induced electromotive force Emf=Em−Im*Rm. Control Circuit 43 then generates an error signal Ee=k*E1−Emf applied to a power amplifier 46, assuring significant improvement in response time. The vibromotor current signal Ic is also used as an auxiliary output useful for calibration of a fastening technique, as indicated later in connection with FIG. 9.

FIG. 7B shows an open-loop implementation of the active drive 15. The input signal E in this implementation generates a prescribed output signal waveform Eout that is known to produce a desired vibrotactile response. Specifically in FIG. 7B, input signal E1 is a square pulse of 208 ms duration and a corresponding tactile stimulus is required. Input signal E1, equalized as in FIG. 7A, is applied to a buffering amplifier 62 that drives resistor R1 connected in parallel with capacitor C1 and the two connected in series with resistor R2. Diode D1 and resistor R3 control the fall time. Voltage at the junction with R2 is applied as an input to a driving amplifier 63 and its output is shown as Eout. It can be seen that Eout in comparison with E accentuates the driving signal at a leading edge thus compensating for the response time of the vibromotor.

Vibrotactile amplitude measured with a square pulse applied to amplifier 63 is shown in FIG. 7C. The vibrotactile amplitude resulting from a correction provided by the active drive in FIG. 7B is shown in FIG. 7D. The desired improvement in the vibrotactile response with Eout can be readily noted. Rise time shortens from 110 ms to 30 ms, fall time from 45 ms to 20 ms.

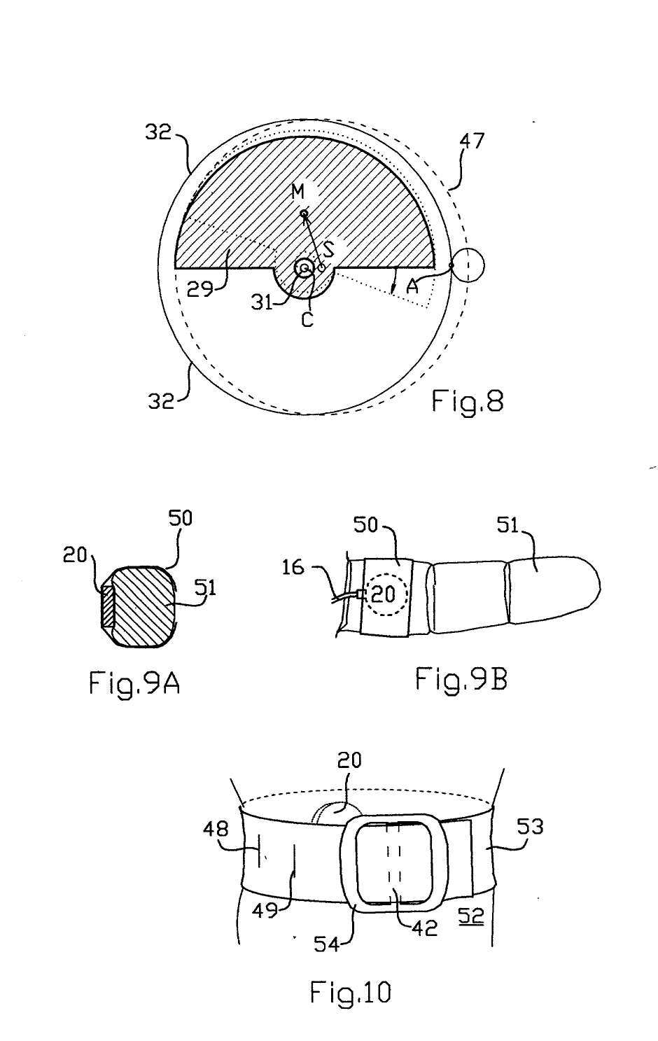

The role of skin fastening support in the adaptation of the flat vibromotor to the role of a vibrotactile transducer is discussed in connection with in FIG. 8. Resulting dynamics involves a superposition of motion of the vibromotor and the underlying skin. In operation, an observer will see a stationary point S that is different from the center of rotation C of the motor.

FIG. 8 is a cross-sectional view through a plane of rotor 29, shown lightly crosshatched. The only other shown elements are shaft 31 and top lid 32 outlining the position of vibromotor 20. Three points are identified in FIG. 8: C is a center of shaft 31 representing the center of motor rotation; M is a center of mass of a semicircular rotor and S is a stationary point. In operation, vibromotor 20 and the underlying skin move in a circular motion around the stationary point S with a radius equal to the segment SC. The dotted lines represent the position of the motor a short time after the position represented by the solid lines. An indication of motion of the housing of vibromotor 20 and the skin during a full rotation of the motor can be inferred from a circular motion of point A on the lower periphery of the motor housing. Dashed circle 47 represents a neutral position on the skin. An instantaneous position of the vibromotor is shown as 32. The deflection of position 32 as from neutral position 47 creates a skin stretch opposing such deflection.

An effective radius of a centrifugal force energizing the vibrotactile transducer is equal to a segment SM and an effective vibrotactile displacement radius is SC. The position of point S is determined by operational parameters of the skin and motor. Particularly important is skin compliance opposing the motion. Value of the skin compliance varies depending on a bias pressure applied to hold the motor against the skin. For a bias pressure that is too light, motor displacement is large but forces applied to the skin are small resulting in poor vibrotactile stimulation. Since power losses increase with excessive motion, efficiency also drops. For a bias pressure that is too heavy, large forces do not compensate for very small skin displacements in a generation of tactile excitation. A successful adaptation of flat vibromotors for vibrotactile transducer operation requires an optimization of the bias pressure between the lid face of the vibromotor and the adjoining skin by fastening means and methods described in the following figures.

A principal component of the centrifugal force acting in a plane of rotation is substantially tangential to the skin. This force causes lateral circular motion of transducer 20 around the center of rotation. Lateral motion encounters constraints due to fastening to the skin. These constraints have a downward component which in turn transfers some of the tangential forces into components perpendicular to the skin. The end result is a nutating motion of the vibromotor 20 and the skin in contact with it. Nutating motion produces a very effective multi-component tactile stimulus. It should be noted that this dynamic is characteristic of tactile skin stimulation and is absent in the “silent alarm” application when a tactile transducer is rigidly mounted to larger enclosure, e.g., the cellular phone, as shown in FIG. 3.

FIG. 9a shows a cross section and FIG. 9b a side view of fastening of flat vibromotor 20 using adhesive tape 50 to a finger 51. The vibromotor is attached to a center of a strip of adhesive tape 50 approximately 12 mm wide and long enough to almost but not quite enclose finger 51. The tape is preferably of a lightweight, flexible translucent, waterproof and hypoallergenic adhesive variety such as Blenderm™ (Blenderm is a trademark of 3M company). The vibromotor is pressed against the skin and one end of the tape is attached to the skin. Another end of the tape is then pulled to tighten the tension on the skin. Initial training of the user is based on a reading of vibromotor current lc generated LX by the active drive in FIG. 7A: The optimum tension corresponds to a specified current. This readout method is used until the user recognizes proper tensioning.

In FIG. 9, the flat vibromotor 20 is attached to a palmar surface of a finger at a mid-portion of a proximal phalanx, substantially midway between the PIP and the MCP joint. In operation, the vibromotor pulling on the tape causes skin motion so that both the top and the bottom lid faces of the flat vibromotor are active in vibrotactile stimulation. Further, the area of tape attachment to the skin contributes to tactile stimulation. The result is that all of the tissue between the PIP and MCP joints is vigorously shaken and vibration can be felt as far as the tip of the finger. This method of fastening couples the primary motion parallel to the skin into a normal and shear component causing a multimodal stimulation of finger tactile receptors.

A hand wearable vibrotactile array can be formed using vibrotactile transducers attached to the palmar surface of the fingers and the thumb as described above, and to an inner surface of the wrist with adhesive tape 50 as a fastener. Flat vibromotors 20 are sufficiently small and lightweight so that wearing this array does not interfere at all with usual activities and is barely noticeable. Further, location of the vibromotors on the palm side of the hand and the translucency of the tape 50 make such an array innocuous and substantially invisible.

FIG. 10 shows fastening of flat vibromotor 20 to a forearm 52 using an elastic band 53. The bias pressure is regulated by an adjusting length of band 53. The adjusting length is moved through a clasp 54 past post 42. The distance between marks 48 and 49 depends on tension of the elastic band 53 and comparing this distance with a specified length provides a means for calibration of bias pressure between vibromotor 20 and the skin.

FIG. 11 shows a fastener used in a specialized application of excess bias pressure. Such a situation exists for example when vibrotactile transducers are used inside a tight fitting garment e.g., inside of a military pilot pressure suit. A surround button 56 is a plastic cylinder with an internal cavity 57. Walls of the cavity 57 are higher than the height of the vibromotor 20 placed in the center of cavity 57. A compliant foam rubber washer 58 centers Vibromotor 20 in the cavity. Roof 55 of the cavity has a conical curvature that matches a conical insert 59 permanently attached to the top face of vibromotor 20.

When a suit 60 presses against the top of surround button 56, pressure is transferred to ring-shaped base 64 of button 56 that rests against skin 19. The resulting indentation of the skin causes skin 19 to raise and touch vibromotor 20 with pressure much reduced from the pressure on the surround base. The radial motion of the vibromotor is partially converted to perpendicular motion by sliding contact along the roof 55 of the cavity 57. Spacing between a radius of the cavity 57 and a radius of vibromotor 20 is sufficient to prevent a direct contact between the two.

Fingers of the hands have a unique property as a site for a vibrotactile array: each finger has its own cutaneous nerve connection in the form of branches of the median, ulnar, and radial nerves. As part of neural hand control, the human brain has evolved specialized capability of interpreting tactile stimuli from the hand. One needs to be only reminded of a performance of a pianist or for that matter a fast typist to appreciate the capabilities of the hands and fingers. Becoming a pianist requires years of training and formation of the neuron connection to act in an automatic manner requiring no conscious effort. Similarly in tactile aids for the hearing impaired, developing an association of tactile patterns with speech is a lengthy process. Still, the sensitivity and resolution of tactile stimuli is better on fingers than on any other part of the human body. The most remarkable is the localization capability of finger—attached tactile transducers.

The key disadvantage of a tactile hand array in the past was that it interfered with the ability of the hands to do other tasks. This is clearly unacceptable in an application such as an aid for the handicapped that must be worn throughout most of the waking hours. The cosmetic aspects of a hand array are also important. Yet another requirement of a viable portable aid is high electrical efficiency that would allow a full day of operation on a single battery charge.

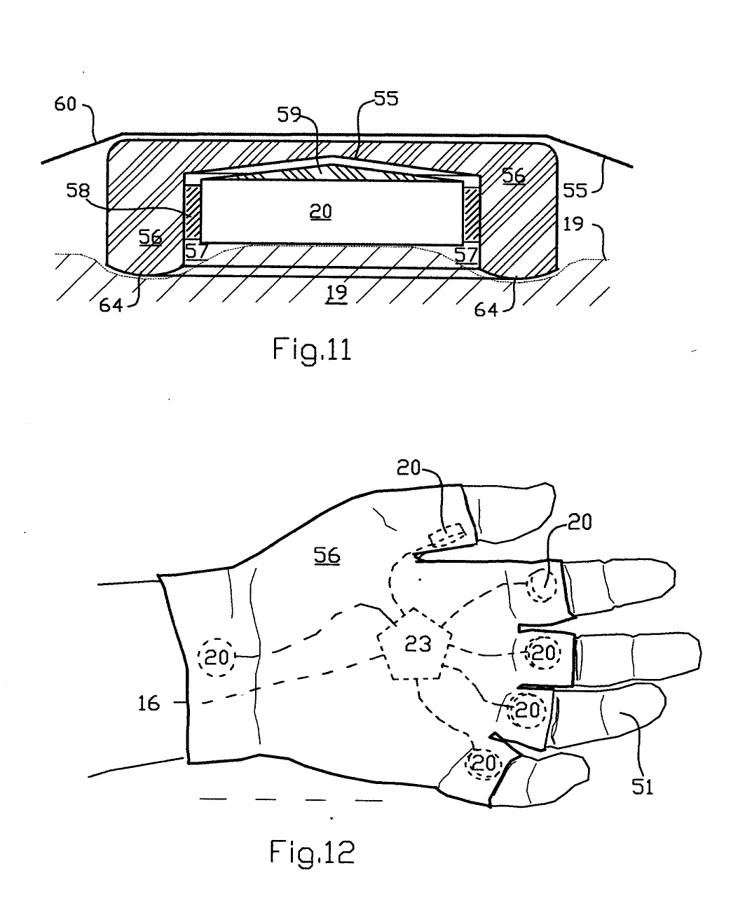

FIG. 12 shows a hand wearable tactile array fastened to skin by a lightweight open-finger glove 56 holding individual vibromotors in appropriate positions for skin contact. Cable 16 connects to a distribution connector 23 and from there to the individual vibromotors 20. The point of attachment of the five vibromotors 20 to the fingers 51 is the finger segment adjacent to the palmar surface of the finger at the mid-portion of the proximal phalanx, substantially midway between the PIP and the MCP joint. A flat vibromotor 20 is attached to the wrist. Flat vibromotors are sufficiently small and lightweight so that wearing this array does not interfere at all with usual activities. The glove implementation of the hand array is more noticeable that the translucent tape implementation discussed in connection with FIG. 9, however the placement of the array is much faster and easier. The elasticity of the glove material and padding allows a fabrication of the glove for an individual user that maintains substantially optimum bias tension conditions. It should be noted that the present invention can be carried out in a variety of modes without departing from the technical ideas or characteristics thereof. Specifically, the hand array can be implemented with other tactile transducers as long as they satisfy the conditions of flatness and efficiency outlined above. Accordingly, the above-described embodiment is an illustration and should therefore not be interpreted limitatively. Further, the technical scope of the present invention is represented by the appended claims and is not bound by the text of the specification.

What is claimed is:

1. A tactile interface comprising:
a driver converting external signals to vibromotor drive signals;
at least one vibromotor comprising an unbalanced rotor, rotating around a stationary shaft;
cables connecting the driver to the vibromotors; and
fastening means for attaching the vibromotors against skin to produce tactile stimulation.

2. A tactile interface according to claim 1, wherein said driver further comprises monitoring means of vibrotactile performance of the vibromotor and adjusts the driving signal of the vibromotor to optimize such a performance in accordance with desired characteristics.

3. A tactile interface according to claim 2, wherein said monitoring means senses a speed-generated electromotive force and adjusts the drive signal for short acceleration and deceleration time to a desired speed.

4. A tactile interface according to claim 1, wherein said driver further comprises a drive signal shaping means that in response to an input signal generates a driving signal shaped to produce a desired tactile response.

5. A tactile interface according to claim 1, wherein said driver provides adjustments for individual vibromotors to equalize tactile stimulation.

6. A tactile interface according to claim 1, wherein said fastening means comprises a cylindrical button with a diameter significantly larger than its height.

7. A tactile interface according to claim 1, wherein said vibromotor combines an actuation function and a vibration-producing function within a single envelope obviating a need for an external rotating shaft and weight.

8. A tactile interface according to claim 1, wherein said fastening means for attaching the vibromotors against skin comprises adhesive tape.

9. A tactile interface according to claim 1, wherein said fastening means for attaching the vibromotors against skin is accomplished by an elastic band.

10. A tactile interface according to claim 9, wherein said elastic band is adjustable and carries marks along its length, spacing between the marks used to determine tension of the band.

11. A tactile interface according to claim 1, wherein said fastening means comprises a garment holding the vibromotors against a prescribed location of the skin.

12. A tactile interface according to claim 11, wherein said garment is a glove holding the vibromotors against a prescribed location of the hand.

13. A tactile interface according to claim 1, wherein said fastening means holds transducers against fingers and thumb.

14. A tactile interface according to claim 13, wherein said fastening means holds transducers against palmar surface of fingers and thumb at mid-portion of a proximal phalanx, substantially midway between a PIP and MCP joint.

15. A tactile interface according to claim 1, wherein said fastening means comprises a button hollowed into a cavity surrounding the vibromotor.

16. A tactile interface according to claim 15, wherein said cavity is shaped so as to cause a gliding motion of the vibromotor for creating a multi-mode vibrotactile stimulation of the skin.

17. A tactile interface according to claim 1, wherein said external signals comprise a processed acoustical signal corresponding to speech and a resulting tactile stimulation pattern corresponds to input speech, such interface being used as an aid for hearing impaired.

18. A tactile interface according to claim 1, wherein said external signals comprise processed environment information and a resulting tactile stimulation pattern aids a wearer in maneuvering in this environment.

19. A tactile interface according to claim 1, wherein said external signals comprise processed virtual environment information and a resulting tactile stimulation pattern aids a wearer in maneuvering in this environment.

20. A method for providing tactile stimulation to a hand in a manner that is cosmetically inoffensive and does not interfere with use of the hand for daily functions, while taking advantage of a unique nerve network of the hand that allows accurate localization of a tactile pattern, comprising steps of:
translating in a driver, external signals to vibromotor drive signals;
fastening a multiplicity of flat vibrotactile transducers that are small, lightweight, and efficient in conversion of electrical energy to vibratory stimulation against skin of the hand; and
connecting said driver to said transducers using cables.

21. A tactile interface comprising:
An active drive that accepts at least one input signal and modifies said signal so as to produce a desired vibrotactile stimulus;
at least one vibrotactile transducer;
cables connecting the active drive to the vibrotactile transducers; and fastening means for attaching the vibrotactile transducers against skin to produce a tactile stimulation pattern.

22. A tactile interface according to claim 21, wherein said active drive is of a closed loop variety that senses the tactile stimulus and by comparing it with the input signal generates an error signal used to drive the vibrotactile transducer.

23. A tactile interface according to claim 21, wherein said active drive is of an open loop variety and comprises a function generator, said function generator, in response to the input signal, producing a driving signal of a form improving the desired vibrotactile stimulus.
